(19) United States
(12) Patent Application Publication
(10) Pub. No.: US 2014/0075395 A1
(43) Pub. Date: Mar. 13, 2014

(54) SEMICONDUCTOR INTEGRATED CIRCUIT DESIGN APPARATUS, SEMICONDUCTOR INTEGRATED CIRCUIT DESIGN METHOD, AND STORAGE MEDIUM

(71) Applicant: KABUSHIKI KAISHA TOSHIBA, Tokyo (JP)

(72) Inventor: Kazunari KIMURA, Kanagawa (JP)

(73) Assignee: KABUSHIKI KAISHA TOSHIBA, Tokyo (JP)

(21) Appl. No.: 13/760,918

(22) Filed: Feb. 6, 2013

(30) Foreign Application Priority Data
Sep. 7, 2012 (JP) 2012-197422

(51) Int. Cl. G06F 17/50

(52) U.S. Cl. CPC G06F 17/5068
USPC 716/51

(57) ABSTRACT

According to an embodiment, in a semiconductor integrated circuit design apparatus for assigning a plurality of wires placed at one wiring layer to a plurality of photomasks, an operation-timing-critical wire is identified from among the plurality of wires placed at a same wiring layer, an adjacent wire which is placed adjacent to the critical wire is extracted, the critical wire and the adjacent wire are laid out such that an interval between the critical wire and the adjacent wire is at least a predetermined distance, and layout patterns of the critical wire and the adjacent wire is assigned to the same photomask.

### CROSS-REFERENCE TO RELATED APPLICATION

This application is based upon and claims the benefit of priority from the Japanese Patent Application No. 2012-197422 filed on Sep. 7, 2012; the entire contents of which are incorporated herein by reference.

### FIELD

Embodiments described herein relate generally to a semiconductor integrated circuit design apparatus, a semiconductor integrated circuit design method, and a storage medium.

### BACKGROUND

Semiconductor integrated circuits are expected to be highly integrated. Pattern miniaturization is essential for high integration. Integration of many devices in a limited narrow area requires forming the individual devices to be small in size. That is, a pitch that is the sum of width of a pattern to be formed and spacing between the pattern and an adjacent pattern needs to be made small. However, a photolithographic process for forming a necessary pattern has a resolution limit, and there are limitations on formation of a pattern with a fine pitch.

In recent years, double patterning has been attracting attention as a pattern forming technique for achieving a fine pitch smaller than a resolution limit. Double patterning is literally a method which allows drawing of a circuit layout pattern with half resolution by performing exposure twice. In the double patterning, a circuit layout pattern at one wiring layer is divided into two (or more) masks. (At the time, the circuit layout pattern is divided such that respective patterns for the masks are large enough to be drawn by an existing exposure machine.) By continuously performing exposure using the two (or more) masks and laying one formed circuits on top of another, fineness smaller than the resolution limit can be achieved.

In double patterning, since a circuit layout pattern at a same wiring layer is manufactured using a plurality of masks, a mask registration error (also called as mask misalignment) occurs in a manufacturing process. The error causes variation in adjacent parasitic capacitance between adjacent layout patterns, which leads to variation in delay of a signal propagating through a circuit.

Especially, in a layout pattern including a timing-critical signal such as a clock signal, a margin corresponding to variation in delay of a signal resulting from a mask registration error in a manufacturing process needs to be taken into consideration as a delay margin in a layout design stage, which causes a problem of an increase in complexity of layout design and extension of a design period.

### BRIEF DESCRIPTION OF THE DRAWINGS

FIG. 1 is a view for explaining an example of a configuration of a semiconductor integrated circuit design apparatus according to the present embodiment;

FIG. 2 is a flow chart for explaining a processing procedure of a design program 31;

FIG. 3 is a flow chart for explaining a procedure for chip layout pattern design;

FIG. 4 is a layout view for explaining an example of a layout pattern at a specific wiring layer which is designed using the design apparatus according to the present embodiment;

FIG. 5 is a view for explaining an example of, when the layout pattern shown in FIG. 4 is assigned to two photomasks, one of the two photomasks;

FIG. 6 is a view for explaining an example of the other photomasks when the layout pattern shown in FIG. 4 is assigned to two photomasks; and

FIG. 7 is a layout view for explaining an example of a layout pattern at a specific wiring layer which is designed using a design apparatus according to a second embodiment.

### DETAILED DESCRIPTION

A semiconductor integrated circuit design apparatus according to an embodiment is a semiconductor integrated circuit design apparatus for assigning a layout pattern including a plurality of wires placed at one wiring layer to a plurality of photomasks, wherein the apparatus identifies a critical wire, a signal delay time period in circuit operation of which determines a signal delay time period of an entire circuit, from the layout pattern including the plurality of wires, extracts an adjacent wire which is placed adjacent to the critical wire, lays out the critical wire and the adjacent wire such that an interval between the critical wire and the adjacent wire is at least a predetermined distance, and assigns layout patterns of the critical wire and the adjacent wire to a same one of the photomasks.

Embodiments will be described below with reference to the drawings.

### First Embodiment

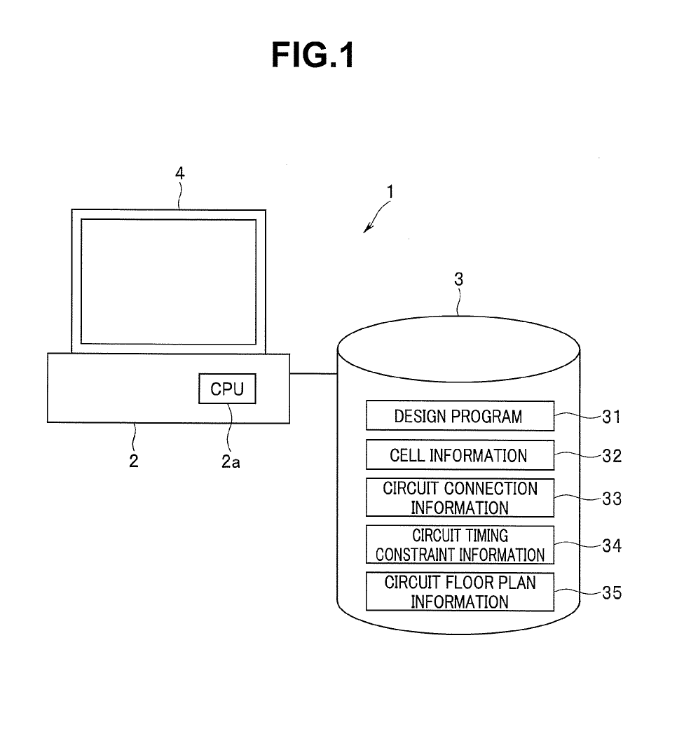

A configuration of a semiconductor integrated circuit design apparatus according to the present embodiment will be described first with reference to FIG. 1. FIG. 1 is a view for explaining an example of the configuration of the semiconductor integrated circuit design apparatus according to the present embodiment.

A semiconductor integrated circuit design apparatus 1 has a main body unit 2 having a central processing unit (hereinafter, referred to as a CPU) 2a configured to execute various software programs, a storage section 3 connected to the main body unit 2 and configured to store the various software programs and the like, and a display section 4 connected to the main body unit 2. Note that although not shown, an input device for a user to give instructions to execute the various programs, such as a keyboard and a mouse, is connected to the main body unit 2.

A design program 31 for semiconductor integrated circuit design, particularly layout design, is stored as one of the various software programs in the storage section 3. Various information files including cell information 32, circuit connection information 33, circuit timing constraint information 34, and circuit floor plan information 35 are stored as various types of information used in the design program 31 in the storage section 3. The CPU 2a of the main body unit 2 can execute or read out a program or the like stored in the storage section 3.

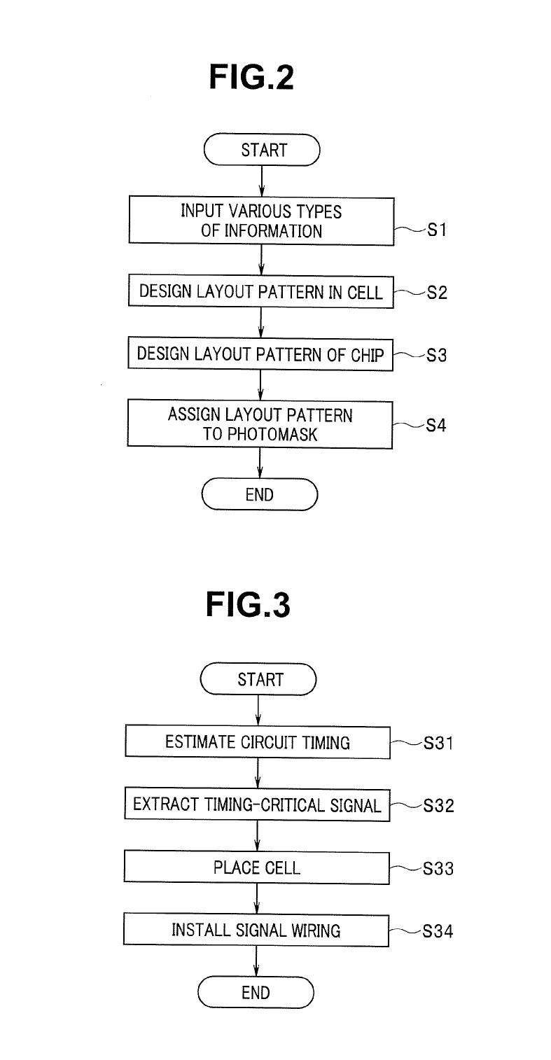

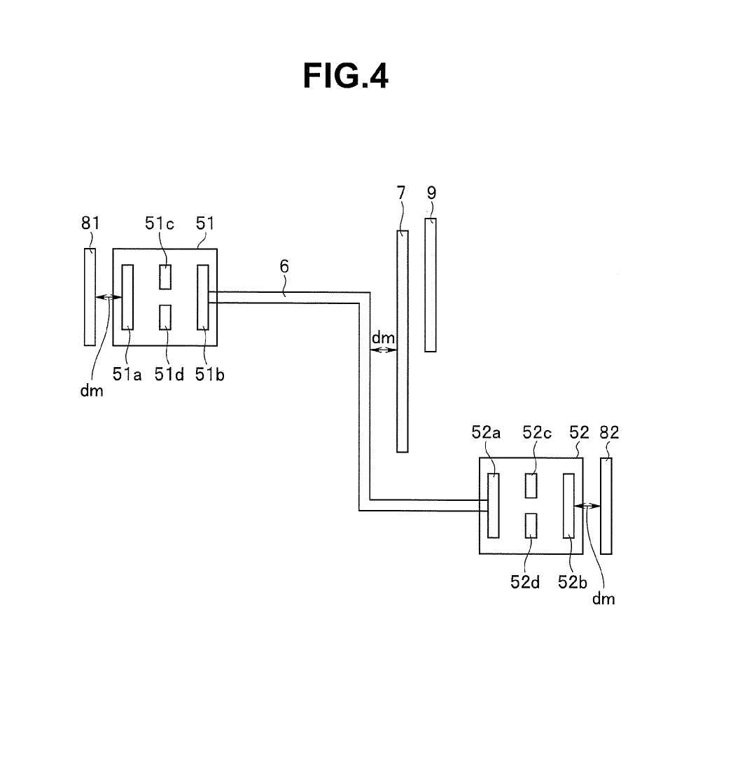

A processing procedure of the design program 31 will be described with reference to FIGS. 2, 3, and 4. FIG. 2 is a flow chart for explaining the processing procedure of the design program 31. FIG. 3 is a flow chart for explaining a procedure for chip layout pattern design (step S3 of the design program 31 shown in FIG. 2). FIG. 4 is a layout view for explaining an example of a layout pattern at a specific wiring layer which is designed using the design apparatus according to the present embodiment.

First, in step S1, various types of information are input for layout design. More specifically, the various information files of the cell information 32, the circuit connection information 33, the circuit timing constraint information 34, the circuit floor plan information 35 stored in the storage section 3 are input. Note that the cell information 32 is a file in which information on cells is described which are basic circuits, such as a logic circuit (e.g., an AND circuit or an OR circuit), a flip-flop circuit, and a memory circuit. The circuit connection information 33 is a file of information on connection of cells in a semiconductor integrated circuit to be designed which has been described in advance in a netlist or the like. The circuit floor plan information 35 is a file in which information on specification of placement of modules (circuit blocks) in the semiconductor integrated circuit is described.

In step S2, a layout pattern in each cell is designed based on the input various types of information. That is, layout patterns as wires necessary in a cell are placed for each of all the cells in the circuit connection information 33. For example, FIG. 4 is a view showing a layout pattern at a specific wiring layer and shows a case where the layout pattern is designed by connecting two cells 51 and 52 by a clock signal wire 6 and placing four wires 7, 81, 82, and 9 around the cells 51 and 52. In the case, layout patterns as wires 51a, 51b, 51c, and 51d of the cell 51 and layout patterns as wires 52a, 52b, 52c, and 52d of the cell 52 are placed in the present step.

The flow advances to step S3 to perform layout design of a chip. In the present step, the cells with the designed internal layout patterns and layout patterns as wires connecting the cells are placed. A detailed procedure of step S3 will be described with reference to FIG. 3. First, in step S31, timing between flip-flops placed in the chip is estimated based on the input various types of information. The flow advances to step S32 and a timing-critical signal is extracted. More specifically, a signal propagating along a path between flip-flops of which timing is critical is extracted as a timing-critical signal using a result of the circuit timing estimation in step S31. A clock is also extracted as a timing-critical signal. In the case of the layout pattern shown in FIG. 4, the clock signal wire 6 is extracted as a timing-critical signal wire.

In step S33, the cells are placed in consideration of a timing-critical signal. More specifically, a cell connected to a timing-critical signal wire is extracted, and the extracted cell is placed such that an interval between a peripheral layout pattern in the extracted cell and an adjacent layout pattern at a same wiring layer is a predetermined distance. The predetermined distance here is a value set prior to the layout design. For example, a minimum spacing (dₘ), with which an existing exposure machine can perform drawing, is set as the predetermined value.

For example, in the case of the layout pattern shown in FIG. 4, the two cells 51 and 52 connected to the clock signal wire 6 that is a timing-critical signal wire are extracted. The cell 51 is placed such that an interval between the wire 51a that is a peripheral layout pattern in the cell and the wire 81 that is an adjacent layout pattern at a same wiring layer is the predetermined value of dₘ. The cell 52 is placed such that an interval between the wire 52b that is a peripheral layout pattern in the cell and the wire 82 that is an adjacent layout pattern at a same wiring layer is the predetermined value of dₘ.

Finally, in step S34, signal wiring is installed in consideration of a timing-critical signal. More specifically, the layout patterns as the individual wires are placed such that an interval between the timing-critical signal wire and the adjacent layout pattern at a same wiring layer is a predetermined distance. As the predetermined distance used in the present step, the minimum spacing (dₘ), with which an existing exposure machine can perform drawing, is set, like the predetermined value used in step S33.

For example, in the case of the layout pattern shown in FIG. 4, layout patterns as the clock signal wire 6 that is a timing-critical signal wire and the wire 7 that is an adjacent layout pattern at a same wiring layer are placed such that an interval between the clock signal wire 6 and the wire 7 is the predetermined value of dₘ.

When the chip layout design in step S3 ends, the flow advances to step S4 to assign a designed layout pattern to a plurality of photomasks. At the time, layout patterns placed with an interval of the predetermined distance between the layout patterns in step S33 (a peripheral layout pattern in a cell connected to a timing-critical signal wire and a layout pattern adjacent to the cell) are assigned to a same photomask. The layout patterns placed with an interval of the predetermined distance between the layout patterns in step S34 (a timing-critical signal wire and a layout pattern adjacent to the timing-critical signal wire) are also assigned to a same photomask.

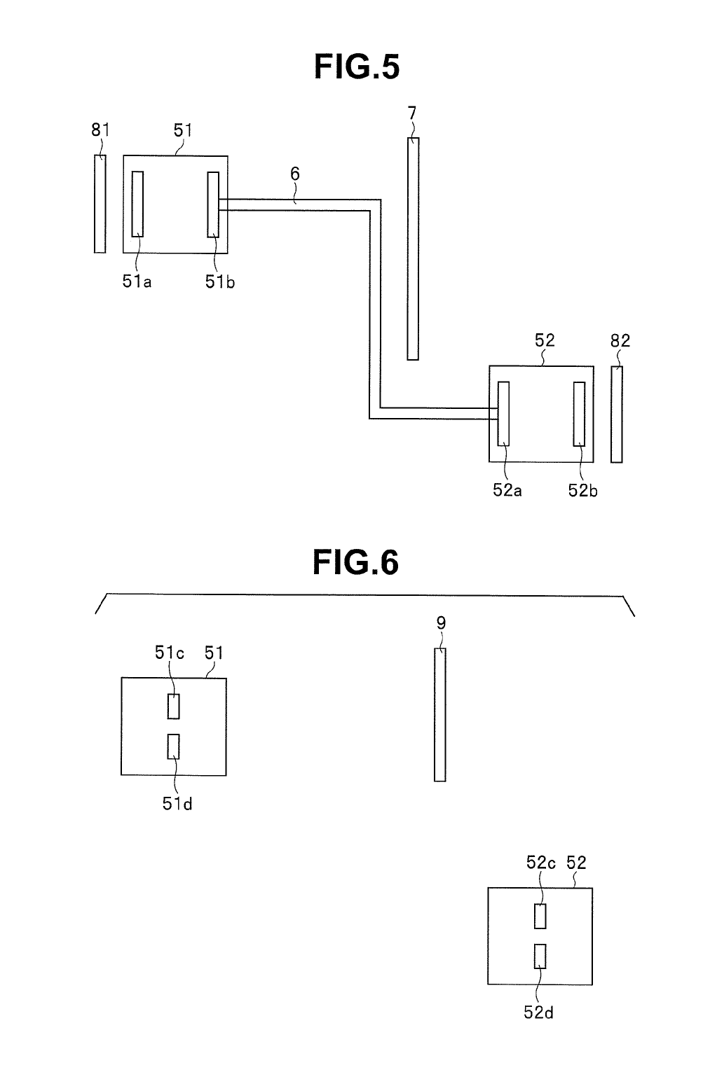

A specific procedure will be described with reference to FIGS. 5 and 6 in the context of a case where the layout pattern shown in FIG. 4 is assigned to two photomasks. FIG. 5 is a view for explaining an example of one of the two photomasks when the layout pattern shown in FIG. 4 is assigned to the photomasks. FIG. 6 is a view for explaining an example of the other of the two photomasks when the layout pattern shown in FIG. 4 is assigned to the photomasks.

Layout patterns placed with an interval of the predetermined distance between the layout patterns in step S33 correspond to a pair of the wire 51a that is a peripheral layout pattern in the cell 51 and the wire 81 that is an adjacent layout pattern and a pair of the wire 52b that is a peripheral layout pattern in the cell 52 and the wire 82 that is an adjacent layout pattern. Accordingly, the pairs of the wires 51a and 81 and the wires 52b and 82 are each assigned to a same photomask. Layout patterns placed with an interval of the predetermined distance between the layout patterns in step S34 correspond to a pair of the clock signal wire 6 and the adjacent wire 7. Accordingly, the clock signal wire 6 and the wire 7 are also assigned to a same photomask.

That is, by assigning a timing-critical signal wire and an adjacent layout pattern to a same photomask, even if a photomask registration error occurs in a manufacturing process, variation does not occur in adjacent parasitic capacitance between the timing-critical signal wire and the adjacent layout pattern, which prevents variation in delay of a signal propagating through a circuit.

Note that other layout patterns are assigned to two photomasks such that an interval between adjacent layout patterns to be placed in a same photomask is not less than the minimum spacing (dₘ), with which an existing exposure machine can perform drawing.

If layout patterns are assigned to the individual photomasks in the above-described manner, for example, the wires 51a and 51b that are layout patterns in the cell 51, the wire 81 adjacent to the cell 51, the wires 52a and 52b that are layout patterns in the cell 52, the wire 82 adjacent to the cell 52, the clock signal wire 6, and the wire 7 adjacent to the clock signal wire 6 are assigned to one of the photomasks, as shown in FIG. 5.

The remaining layout patterns that are not assigned to the photomask are assigned to the other photomask. For example, the wires 51c and 51d that are layout patterns in the cell 51, the wires 52c and 52d that are layout patterns in the cell 52, and the wire 9 are assigned to the other photomask, as shown in FIG. 6.

When the assignment of the layout pattern to the plurality of photomasks in step S4 ends, processing of the design program 31 ends.

As described above, according to the present embodiment, in a case where a layout pattern at a same wiring layer is assigned to a plurality of photomasks by double patterning, a timing-critical signal is extracted from the layout pattern, and a wire for the timing-critical signal and a layout pattern adjacent to the wire are placed such that an interval between the timing-critical signal wire and the adjacent layout pattern is the minimum spacing (dₘ), with which an existing exposure machine can perform drawing. The configuration allows assignment of the layout patterns to a same photomask.

Since a timing-critical signal wire and an adjacent layout pattern are assigned to a same photomask, even if a photomask registration error occurs in a manufacturing process, variation does not occur in adjacent parasitic capacitance between the timing-critical signal wire and the adjacent layout pattern. Thus, variation in delay of a signal propagating through a circuit can be reduced. Additionally, layout design can be performed without consideration of variation in signal delay in a critical signal as a delay margin, which allows curbing of an increase in layout design cost and a layout design period.

Note that if there are a plurality of timing-critical signals, all of the signals need not be assigned to a same photomask and may be assigned to separate photomasks. Note that a timing-critical signal wire and an adjacent layout pattern need to be assigned to a same photomask. For example, if a different clock signal wire is placed at a same wiring layer in addition to the clock signal wire 6 shown in FIG. 4, the clock signal wire 6 and the wire 7 that is an adjacent layout pattern may be assigned to one of the photomasks, and the different clock signal wire and a layout pattern adjacent to the different clock signal may be assigned to the other photomask.

An interval between the timing-critical signal wire and the adjacent layout pattern only needs to be at least the minimum spacing (dₘ), with which an existing exposure machine can perform drawing, and may be larger than the minimum spacing.

### Second Embodiment

In the semiconductor integrated circuit design apparatus according to the above-described first embodiment, a timing-critical signal wire and an adjacent layout pattern at a same wiring layer are placed such that an interval between the timing-critical signal wire and the adjacent layout pattern is the minimum spacing (dₘ), with which an existing exposure machine can perform drawing, and are assigned to a same photomask. The present embodiment is different in that layout patterns at a same wiring layer in a cell connected to a timing-critical signal wire are also placed such that an interval between the layout patterns is a minimum spacing (dₘ), with which an existing exposure machine can perform drawing, and are assigned to a same photomask.

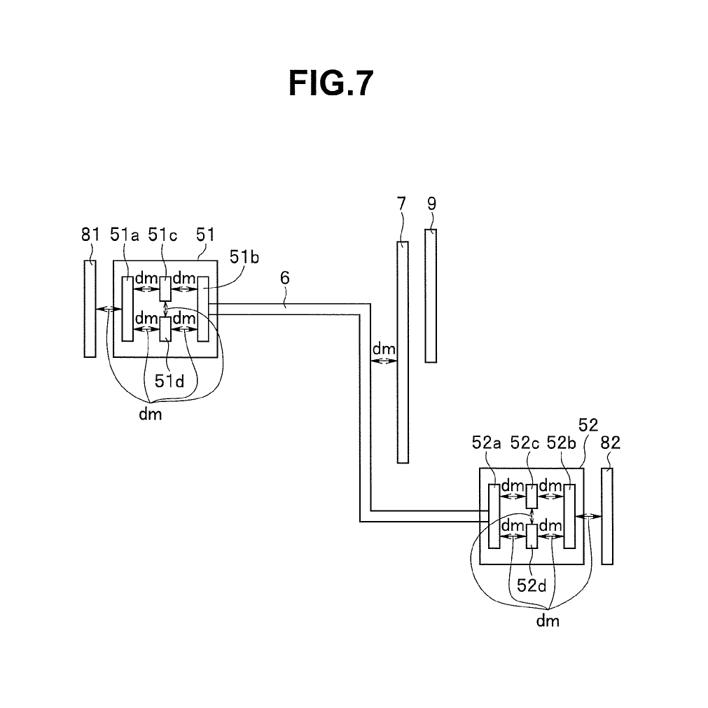

That is, in step S2 of a design program 31 shown in FIG. 2, for a cell connected to a timing-critical signal wire, a layout pattern is set such that an interval between layout patterns at a same wiring layer in the cell is also the minimum spacing (dₘ), with which an existing exposure machine can perform drawing. In step S33 of the layout design procedure shown in FIG. 3, after a cell connected to a timing-critical signal wire is extracted, a cell, a layout pattern of which has been designed for a cell connected to a timing-critical signal wire in step S2, is used for the extracted cell. A peripheral layout pattern in the extracted cell and a layout pattern adjacent to the cell are placed such that an interval between the layout patterns is the minimum spacing (dₘ), with which an existing exposure machine can perform drawing. For example, in the case of the layout pattern shown in FIG. 4 used in the first embodiment, a cell, a layout pattern of which is designed such that an interval between layout patterns in the cell is also the predetermined value (dₘ), is used as each of two cells 51 and 52 connected to a clock signal wire 6 which is a timing-critical signal wire (see FIG. 7).

FIG. 7 is a layout view for explaining an example of a layout pattern which is designed using a design apparatus according to the second embodiment. As shown in FIG. 7, a cell, a layout pattern of which is set such that intervals between respective pairs of layout patterns in the cell, i.e., an interval between a wire 51a and a wire 51c, an interval between the wire 51a and a wire 51d, an interval between a wire 51b and the wire 51c, an interval between the wire 51b and the wire 51d, and an interval between the wire 51c and the wire 51d are the predetermined value (dₘ), is used as the cell 51. Like the first embodiment, the cell 51 is placed such that an interval between the wire 51a that is a peripheral layout pattern in the cell and a wire 81 that is an adjacent layout pattern is the predetermined value (dₘ). A cell, a layout pattern of which is set such that intervals between respective pairs of layout patterns in the cell, i.e., an interval between a wire 52a and a wire 52c, an interval between the wire 52a and a wire 52d, an interval between a wire 52b and the wire 52c, an interval between the wire 52b and the wire 52d, and an interval between the wire 52c and the wire 52d are the predetermined value (dₘ), is used as the cell 52. Like the first embodiment, the cell 52 is placed such that an interval between the wire 52b that is a peripheral layout pattern in the cell and a wire 82 that is an adjacent layout pattern is the predetermined value (dₘ).

In step S4 of the design program shown in FIG. 2, layout patterns in a cell connected to a timing-critical signal wire are assigned to a same photomask, like a layout pattern adjacent to the timing-critical signal wire. For example, in a layout pattern shown in FIG. 7, the clock signal wire 6 which is a timing-critical signal wire, the internal wires 51a to 51d and 52a to 52d of the cells 51 and 52 connected to the clock signal wire 6, a wire 7 adjacent to the clock signal wire 6, the wire 81 that is a layout pattern adjacent to the wire 51a that is a peripheral layout pattern in the cell 51, and the wire 82 that is a layout pattern adjacent to the wire 52b that is a peripheral layout pattern in the cell 52 are all assigned to a same photomask. Accordingly, only a remaining wire 9 is assigned to the other photomask. Other components and layout design procedure steps are the same as in the first embodiment and are denoted by same reference numerals. A description of the components and steps will be omitted.

As described above, layout patterns in a cell connected to a timing-critical signal wire are placed such that an interval between the layout patterns is also the predetermined value (dₘ) and are assigned to a same photomask. With the configuration, even if a photomask registration error occurs in a manufacturing process, variation in delay of a signal propagating a timing-critical signal can be further reduced.

Note that all or part of a program that executes the above-described operations may be recorded on or stored in a non-temporary portable medium such as a flexible disk and a CD-ROM or a non-temporary computer-readable medium that is a storage medium such as a hard disk, as a computer program product. The program is read by a computer, and all or part of the operations are executed. Alternatively, all or part of the program can be distributed or provided over a communication network. A user can easily implement semiconductor integrated circuit design apparatuses and semiconductor integrated circuit design methods according to the present embodiments by downloading the program over a communication network and installing the program in a computer or installing the program in the computer from a recording medium.

While certain embodiments have been described, these embodiments have been presented by way of example only, and are not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. A semiconductor integrated circuit design apparatus for assigning a layout pattern including a plurality of wires placed at one wiring layer to a plurality of photomasks,
wherein the apparatus identifies a critical wire, a signal delay time period in circuit operation of which determines a signal delay time period of an entire circuit, from the layout pattern including the plurality of wires, extracts an adjacent wire which is placed adjacent to the critical wire, lays out the critical wire and the adjacent wire such that an interval between the critical wire and the adjacent wire is at least a predetermined distance, and assigns layout patterns of the critical wire and the adjacent wire to a same first photomask.

2. The semiconductor integrated circuit design apparatus according to claim 1, wherein
the apparatus identifies the critical wire based on timing constraint information for the plurality of wires.

3. The semiconductor integrated circuit design apparatus according to claim 1, wherein
the critical wire includes at least a clock signal wire.

4. The semiconductor integrated circuit design apparatus according to claim 1, wherein
the predetermined distance is a minimum space with which an exposure machine can perform drawing.

5. The semiconductor integrated circuit design apparatus according to claim 1, wherein
the apparatus lays out a cell placed to be connected to the critical wire such that an interval between an intra-cell outermost wire placed in an outermost region in the cell and a cell adjacent wire placed adjacent to the cell is at least the predetermined distance and assigns layout patterns of the intra-cell outermost wire and the cell adjacent wire to the first photomask.

6. The semiconductor integrated circuit design apparatus according to claim 1, wherein
the apparatus lays out a plurality of the intra-cell wires to be installed in a cell placed to be connected to the critical wire such that an interval between the plurality of intra-cell wires is at least the predetermined distance and assigns the plurality of intra-cell wires to the first photomask.

7. The semiconductor integrated circuit design apparatus according to claim 4, wherein
the apparatus lays out a cell placed to be connected to the critical wire such that an interval between an intra-cell outermost wire placed in an outermost region in the cell and a cell adjacent wire placed adjacent to the cell is at least the predetermined distance and assigns layout patterns of the intra-cell outermost wire and the cell adjacent wire to the first photomask.

8. The semiconductor integrated circuit design apparatus according to claim 7, wherein
the critical wire includes at least a clock signal wire.

9. The semiconductor integrated circuit design apparatus according to claim 7, wherein
the apparatus lays out a plurality of the intra-cell wires to be installed in the cell placed to be connected to the critical wire such that an interval between the plurality of intra-cell wires is at least the predetermined distance and assigns layout patterns of the plurality of intra-cell wires to the first photomask.

10. The semiconductor integrated circuit design apparatus according to claim 9, wherein
the critical wire includes at least a clock signal wire.

11. The semiconductor integrated circuit design apparatus according to claim 9, wherein
the apparatus identifies the critical wire based on timing constraint information for the plurality of wires.

12. A semiconductor integrated circuit design method for assigning a layout pattern including a plurality of wires placed at one wiring layer to a plurality of photomasks, comprising:
identifying a critical wire, a signal delay time period in circuit operation of which determines a signal delay time period of an entire circuit, from among the plurality of wires;
extracting an adjacent wire which is placed adjacent to the critical wire;
laying out the critical wire and the adjacent wire such that an interval between the critical wire and the adjacent wire is at least a predetermined distance; and
assigning layout patterns of the critical wire and the adjacent wire to a same first photomask.

13. The semiconductor integrated circuit design method according to claim 12, wherein
the identifying comprises identifying the critical wire based on timing constraint information for the plurality of wires.

14. The semiconductor integrated circuit design method according to claim 12, wherein
the predetermined distance is a minimum space with which an exposure machine can perform drawing.

15. The semiconductor integrated circuit design method according to claim 12, further comprising
laying out a cell placed to be connected to the critical wire such that an interval between an intra-cell outermost wire placed in an outermost region in the cell and a cell adjacent wire placed adjacent to the cell is at least the predetermined distance and assigning layout patterns of the intra-cell outermost wire and the cell adjacent wire to the first photomask.

16. The semiconductor integrated circuit design method according to claim 14, further comprising
laying out a cell placed to be connected to the critical wire such that an interval between an intra-cell outermost wire placed in an outermost region in the cell and a cell adjacent wire placed adjacent to the cell is at least the predetermined distance and assigning layout patterns of the intra-cell outermost wire and the cell adjacent wire to the first photomask.

17. The semiconductor integrated circuit design method according to claim 16, further comprising
laying out a plurality of the intra-cell wires to be installed in a cell placed to be connected to the critical wire such that an interval between the plurality of intra-cell wires is at least the predetermined distance and assigning the plurality of intra-cell wires to the first photomask.

18. The semiconductor integrated circuit design method according to claim 17, wherein
the critical wire includes at least a clock signal wire.

19. A non-temporary storage medium storing a semiconductor integrated circuit design program to be executed by a computer, the design program comprising:
a procedure for identifying a critical wire, a signal delay time period in circuit operation of which determines a signal delay time period of an entire circuit, from among a plurality of wires placed at one wiring layer;
a procedure for extracting an adjacent wire which is placed adjacent to the critical wire;
a procedure for laying out the critical wire and the adjacent wire such that an interval between the critical wire and the adjacent wire is at least a predetermined distance; and
a procedure for assigning layout patterns of the critical wire and the adjacent wire to a first photomask and assigning a layout pattern of a remaining wire of the plurality of wires to a different photomask.

20. The non-temporary storage medium storing a semiconductor integrated circuit design program according to claim 19, the design program further comprising:
a procedure for laying out a cell placed to be connected to the critical wire such that an interval between an intra-cell outermost wire placed in an outermost region in the cell and a cell adjacent wire placed adjacent to the cell is at least the predetermined distance; and
a procedure for assigning layout patterns of the intra-cell outermost wire and the cell adjacent wire to the first photomask.
